(19) United States
(12) Patent Application Publication
(10) Pub. No.: US 2023/0381717 A1
(43) Pub. Date: Nov. 30, 2023

(54) MODULAR FRAME FOR HEAT OR MASS-EXCHANGE MODULE

(71) Applicant: ROCHEM SEPARATION SYSTEM INDIA (P) LTD., Maharashtra (IN)

(72) Inventor: Prayas GOEL, Maharashtra (IN)

(21) Appl. No.: 18/030,708

(22) PCT Filed: Oct. 7, 2021
(86) PCT No.: PCT/IN2021/050965

§ 371 Date: Apr. 6, 2023

(30) Foreign Application Priority Data
Oct. 7, 2020 (IN) 202021043600

(51) Int. Cl. B01D 63/08; F28D 9/00

(52) U.S. Cl. CPC B01D 63/0822; F28D 9/0037; B01D 2313/041; B01D 2313/54; B01D 2313/14

(57) ABSTRACT

A modular frame (20) comprises three distinct sections, an outer section (1), a flow section (2), and an active section (3). The frame further comprises a gasket (22, 23) positioned adjacent to the modular frame (20). Further a distance bar (21) extends away from periphery of the modular frame (20). Further the outer section (1) comprises an outer frame (27) and an inner frame (26), wherein a plurality of cross-member (40) are positioned between outer frame (27) and an inner frame (26). The active section (3) further comprises a grid (14) consisting of plurality of flow channels. The flow section (2) further comprises one internal flow passage (15, 16) and one external flow passage (17, 18), wherein the at least one internal flow passage (15, 16) and the at least one external flow passage (17, 18) are connected to the grid (14) in the active section (3).

### TECHNICAL FIELD

The present disclosure relates to a system for fluid separation, more particularly the disclosure relates to a modular frame configured to enable fluid separation and allow transfer of heat or mass.

### BACKGROUND

Systems with a plurality of modular frame elements are known in the art. In accordance with a reference a plurality of modular frame elements as disclosed are welded together to form a web structure. Further these web structures are stacked to form different functional units such as in particular a membrane distillation stage, a steam generator, a condenser, a heat exchanger, a filter, and/or a pervaporation stage.

Further each frame elements provided on both sides of a welded web structure provide the region comprising the passage openings and the central inner region on one hand and, on the other hand, at least two regions, each comprising a vapour and/or liquid channel.

However, the disclosed reference has been found have efficiency far from a theoretically possible optimum. i.e. configuration of the frame elements do not allow a significant increase in efficiency.

### SUMMARY

Before the present systems to separate fluid is described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is not intended to identify essential features of the claimed subject matter nor is it intended for use in determining or limiting the scope of the claimed subject matter.

In one implementation, a modular frame (20) is disclosed. The modular frame (20) may comprise at least three distinct sections, wherein the three sections are an outer section (1), a flow section (2), and an active section (3), wherein the flow section (2) is positioned between the outer section (1), and an active section (3). The frame may further comprise a gasket (22, 23) positioned adjacent to the modular frame (20). Further a distance bar (21) may extend away from periphery of the modular frame (20), wherein the distance bar (21) is configured to provide pre-defined gap between two modular frames (20). Further the outer section (1) may comprises an outer frame (27) and an inner frame (26), wherein a plurality of cross-member (40) are positioned between outer frame (27) and an inner frame (26). The active section (3) may further comprises a grid (14) consisting of plurality of flow channels. The flow section (2) may further comprises at least one internal flow passage (15, 16) and at least one external flow passage (17, 18), wherein the at least one internal flow passage (15, 16) and the at least one external flow passage (17, 18) are connected to the grid (14) in the active section (3).

In another implementation of the present disclosure a fluid separation system comprising a plurality of modular frames (20) is disclosed. The plurality of modular frames may be fastened together without welding. Further each modular frame may comprise at least three distinct sections, wherein the three sections are an outer section (1), a flow section (2), and an active section (3), wherein the flow section (2) is positioned between the outer section (1), and an active section (3). Further a first gasket (22) and a second gasket (23) positioned between the plurality of modular frame (20). Further a distance bar (21) may extend away from periphery of the modular frame (20), wherein the distance bar (21) is configured to provide pre-defined gap between two modular frames (20). Further the outer section (1) may comprises an outer frame (27) and an inner frame (26), wherein a plurality of cross-member (40) are positioned between outer frame (27) and an inner frame (26). The active section (3) may further comprises a grid (14) consisting of plurality of flow channels. The flow section (2) may further comprises at least one internal flow passage (15, 16) and at least one external flow passage (17, 18), wherein the at least one internal flow passage (15, 16) and the at least one external flow passage (17, 18) are connected to the grid (14) in the active section (3).

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a frame in accordance with the present disclosure.

FIG. 2 illustrates the flow section in accordance with the present disclosure.

FIG. 3 illustrates an exemplary embodiment of the frame, in accordance with the present disclosure.

FIG. 4 illustrates another exemplary embodiment of the frame, in accordance with the present disclosure.

Referring to FIG. 5, illustrates a gasket in accordance with an exemplary embodiment of the present disclosure.

It should be appreciated by those skilled in the art that any block diagrams herein represent conceptual views of illustrative systems embodying the principles of the present invention. Similarly, it will be appreciated that any flowcharts, flow diagrams, and the like represent various processes which may be substantially represented in computer readable medium and so executed by a computer or processor, whether or not such computer or processor is explicitly shown.

### DETAILED DESCRIPTION

Some embodiments of the present disclosure, illustrating all its features, will now be discussed in detail. It must also be noted that as used herein and in the appended claims, the singular forms “a”, “an” and “the” include plural references unless the context clearly dictates otherwise. Although any systems and methods similar or equivalent to those described herein can be used in the practice of embodiments of the present disclosure, the exemplary, systems for an improved modular frame for fluid separation is now described. The disclosed embodiments of the system for an improved modular frame for fluid separation are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for an improved modular frame for fluid separation is not intended to be limited to the embodiments illustrated, but is to be accorded the widest scope consistent with the principles and features described herein.

In accordance with an exemplary embodiment the present disclosure discloses a modular frame configured to enable fluid separation, heat/mass transfer. Further plurality of modular frames as disclosed may be joined together to form or create or fabricate a fluid separation system, wherein the plurality of modular frames are joined together with each other using fastener or other means, except welding the plurality of frames together. Further in accordance with the exemplary embodiment a gasket may be placed between each modular frame in the plurality of frames.

Each frame in accordance with the exemplary embodiment may have three distinct zone. The three zones can be an outer zone/framework, a fluid/functional zone/area, and an inner area. The outer framework/section may be configured to provide mechanical stability to the entire frame. Further the fluid/functional area or flow section may enable liquid and vapor flow within each frame. The active section or inner area in accordance with the exemplary embodiment may be configured to enable or provide for mass and heat transfer within the frame or within another adjacent frame. The frame material as disclosed may be any polymer that can be injection molded and is chemically stable against the treated fluid, for e.g. in high temperature and aggressive fluid applications PVDF may be used.

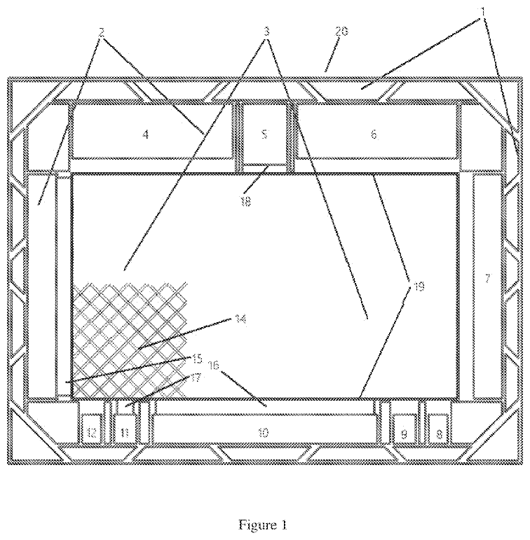

Now referring to FIG. 1, illustrates a frame in accordance with the present disclosure. The frame 20 as disclosed may comprise at least three distinct sections. The at least three distinct sections may be outer section (1), a flow section (2), and an active section (3). In accordance with the disclosure the outer section (1) may be configured to provide a mechanical stability and further act as a barrier to compensate pressure differences created inside of the frame and the ambient pressure outside the frame, i.e. between the outer section (1), the flow section (2), and the active section and ambient pressure outside the frame.

The flow section (2) of the frame may be provided with a plurality of chambers (4, 5, 6, 7, 8, 9, 10, 11, 12 and 13) positioned adjacent to each other. Further one or more chambers may be selected and activated for fluid or vapour flow through them based on the functionality or process to be performed. Further the flow section (2) may further comprises at least one internal flow passage (15, 16) and at least one external flow passage (17, 18), wherein the at least one internal flow passage (15, 16) and the at least one external flow passage (17, 18) are connected to a grid (14) in the active section (3).

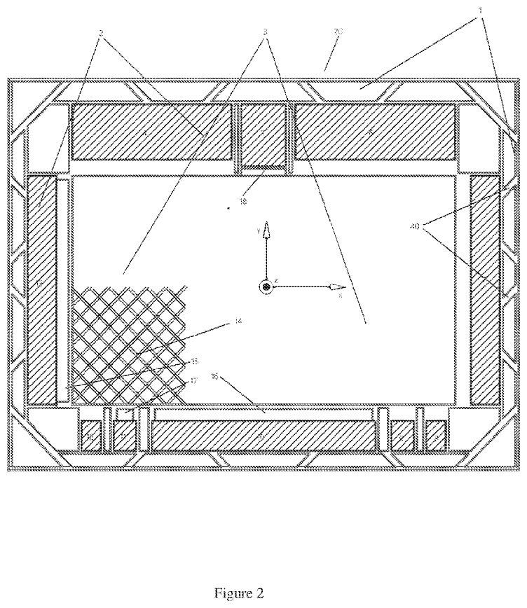

Referring to FIG. 2, illustrates the flow section in accordance with the present disclosure. The flow section (2) of the frame as disclosed may comprise a plurality of chambers (4, 5, 6, 7, 8, 9, 10, 11, 12 and 13) positioned adjacent to each other and around or enclosing the active region (3). Each chamber from the plurality of chambers (4, 5, 6, 7, 8, 9, 10, 11, 12 and 13) as disclosed may further be connected with the at least one internal flow passage (15, 16), or the at least one external flow passage (17, 18) at one end and with the grid (14) in the active section (3). Each chamber may be independently activated or selected based on the separation or process required.

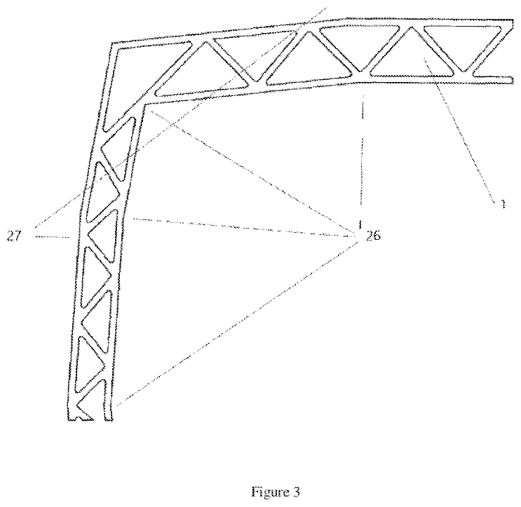

Referring to FIG. 3, illustrates an exemplary embodiment of the frame, in accordance with the present disclosure. The outer section (1) may further comprises an outer frame (27) and an inner frame (26). In accordance with the exemplary embodiment a plurality of cross-member (40) may positioned between outer frame (27) and an inner frame (26). Further the inner frame (26) may have a plurality of bends at pre-set distance along entire periphery of the inner frame (26) with a specific angle for each bend.

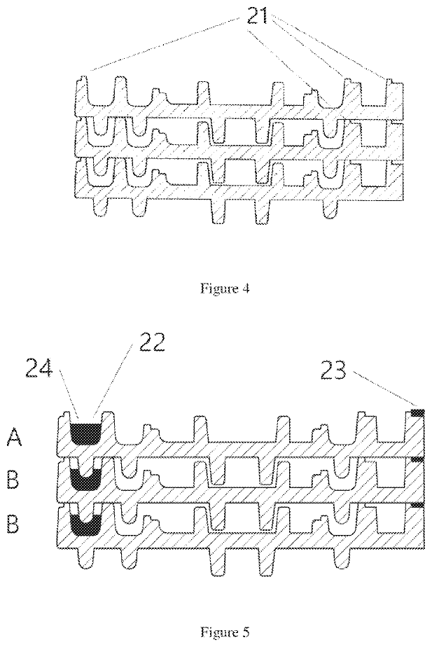

Referring to FIG. 4 illustrates another exemplary embodiment of the frame, in accordance with the present disclosure. Each modular frame 20, in accordance with present disclosure may have an upper periphery, i.e. exposed to open when placed on ground, and lower periphery i.e. on opposite side of the upper periphery. Further when two modular frame 20 are placed over each other, the upper periphery of the first modular frame may be in contact with the lower periphery of the second modular frame placed over the first modular frame. Further to have perfect fit between the two modular frames 20, and at pre-defined distance, each frame 20 may further comprise a distance bar (21) extending away from the upper periphery. The distance bar (21) in accordance with the embodiment may be configured to provide pre-defined gap between two modular frames (20).

Now Referring to FIG. 5, illustrates a gasket in accordance with an exemplary embodiment of the present disclosure. In accordance with the disclosure the fluid separation system may comprise a gasket (22, 23), positioned adjacent or over the modular frame (20). Further the frame 20 may comprise a groove (24) configured to receive the gasket (22, 23).

In accordance with another exemplary the system may comprise at least two gaskets, i.e. a first gasket (22) and a second gasket (23). In position A the first gasket (22) and the second gasket (23) are relaxed in position, while in position B the first gasket (22) and the second gasket (23) are compressed. Further in accordance with the embodiment the distance bars (21) may protect the first gasket (22), and the second gasket (23) are compressed only to a certain extent. The first gasket (22) may be configured to separate the internal pressure in a frame 20 from ambient pressure, and the first gasket is positioned in the groove (24). The groove protects the first gasket (22) against mechanical damage. Further the second gasket (23) may separate the outside ambient pressure from the inner pressure in the frame 20. Further the second gasket 23 may separate the fluid flows, liquid and vapor, in the flow section 2. Further the first gasket (22) and the second gasket (23) are closed loops.

I/We claim:

1. A modular frame (20) comprising:
at least three distinct sections, wherein the three sections are an outer section (1), a flow section (2), and an active section (3), wherein the flow section (2) is positioned between the outer section (1), and an active section (3);
characterized wherein, a gasket (22, 23) positioned adjacent to the modular frame (20);
a distance bar (21) extending away from periphery of the modular frame (20), wherein the distance bar (21) is configured to provide pre-defined gap between two modular frames (20);
the outer section (1) further comprises an outer frame (27) and an inner frame (26), wherein a plurality of cross-member (40) are positioned between outer frame (27) and an inner frame (26);
the active section (3) further comprises a grid (14) consisting of plurality of flow channels; and
the flow section (2) further comprises at least one internal flow passage (15, 16) and at least one external flow passage (17, 18), wherein the at least one internal flow passage (15, 16) and the at least one external flow passage (17, 18) are connected to the grid (14) in the active section (3).

2. The modular frame (20) as claimed in claim 1, wherein the inner frame (26) has plurality of bends at pre-set distance along entire periphery of the inner frame (26).

3. The modular frame (20) as claimed in claim 1, the flow section (2) further comprises a plurality of chambers (4, 5, 6, 7, 8, 9, 10, 11, 12 and 13) positioned adjacent to each other.

4. The modular frame (20) as claimed in claim 1, further comprises a groove (24) configured to receive the gasket (22).

5. A fluid separation system comprises:
a plurality of modular frames 20, fasten together without welding, wherein each frame comprises:
at least three distinct sections, wherein the three sections are an outer section (1), a flow section (2), and an active section (3), wherein the flow section (2) is positioned between the outer section (1), and an active section (3);
characterized wherein, a first gasket (22) and a second gasket (23) positioned between the plurality of modular frame (20);
a distance bar (21) extending away from periphery of the modular frame (20), wherein the distance bar (21) is configured to provide pre-defined gap between two modular frames (20);
the outer section (1) further comprises an outer frame (27) and an inner frame (26), wherein a plurality of cross-member (40) are positioned between outer frame (27) and an inner frame (26);
the active section (3) further comprises a grid (14) consisting of plurality of flow channels; and
the flow section (2) further comprises at least one internal flow passage (15, 16) and at least one external flow passage (17, 18), wherein the at least one internal flow passage (15, 16) and the at least one external flow passage (17, 18) are connected to the grid (14) in the active section (3).

6. The fluid separation system as claimed in claim 5, wherein the inner frame (26) has plurality of bends at pre-set distance along entire periphery of the inner frame (26).

7. The fluid separation system as claimed in claim 5, the flow section (2) further comprises a plurality of chambers (4, 5, 6, 7, 8, 9, 10, 11, 12 and 13) positioned adjacent to each other.

8. The modular frame (20) as claimed in claim 1, further comprises a groove (24) configured to receive the first gasket (22).
